(19) United States
(12) Patent Application Publication
(10) Pub. No.: US 2026/0049949 A1
(43) Pub. Date: Feb. 19, 2026

(54) Normality Level Analyzing System

(71) Applicant: Hitachi High-Tech Corporation, Tokyo (JP)

(72) Inventors: Ayumi TOMIYAMA, Tokyo (JP); Takanori KONDO, Hillsboro, OR (US); Yugo ONODA, Tokyo (JP); Masato ISHIMARU, Tokyo (JP)

(21) Appl. No.: 18/802,268

(22) Filed: Aug. 13, 2024

(51) Int. Cl. G01N 21/95

(52) U.S. Cl. CPC G01N 21/9501; G01N 2201/126

(57) ABSTRACT

An objective of the present disclosure is to provide a technique for identifying normality level/abnormality level of sample processed by processing tool. The system according to the present disclosure comprises: a learner configured to learn a relationship between measurement data that describes a measurement result acquired by a first measuring tool and test data that describes a measurement result acquired by a second measuring tool which measures the sample after a manufacturing process for the sample is finished; and a processor that estimates, using the learner, a normality level or an abnormality level of the sample measured by the second measuring tool.

### TECHNICAL FIELD

The present disclosure relates to a technique for analyzing normality level of a sample processed by a processing tool.

### BACKGROUND ART

In order to find defects at early stages, users of semiconductor manufacturing line measure processed wafers by inline inspection tool, thereby determining whether the wafer is normal/abnormal according to a predetermined condition. Then the user takes measures onto abnormal cases. For example, if the inline inspection tool is a defect inspection tool, the inspection tool detects defects in the wafer processed by a processing tool. The user determines whether the wafer is normal or abnormal according to whether the inspected result (e.g. number of defects, position of defects, etc.) satisfies the predetermined condition.

Patent Literature 1 discloses a method for screening dies using inline defect information with machine learning.

### CITATION LIST

### Patent Literature

Patent Literature 1: US2020/0312778

### SUMMARY OF INVENTION

### Technical Problem

The objective of defect inspection tool is to extract defective wafers. Thus the inspection result of inspection tool focuses on defective wafers, and then normal wafers will not be further inspected so that such normal wafers will be sent to subsequent processes quickly. In addition, since defect inspection tool detects abnormalities, normal wafers are uniformly categorized as normal. Thus it is not assumed to more specifically categorize normal wafers such as into wafers with highest quality or into wafers that are relatively close to defective wafers.

Patent Literature 1 above focuses on defective dies, and does not specifically describe about how normal wafers will be handled. In addition, although Patent Literature 1 mentions about categorizing wafers into normal/abnormal wafers, there is no mention about the degree of normality/degree of abnormality of the wafer.

An objective of the present disclosure is to provide a technique for identifying normality level/abnormality level of sample processed by processing tool.

### Solution to Problem

The system according to the present disclosure comprises: a learner configured to learn a relationship between measurement data that describes a measurement result acquired by a first measuring tool and test data that describes a measurement result acquired by a second measuring tool which measures the sample after the whole manufacturing process for the sample is finished; and a processor that estimates, using the learner, a normality level or an abnormality level of the sample measured by the second measuring tool.

### Advantageous Effects of Invention

According to the system of the present disclosure, it is possible to provide a technique for identifying normality level/abnormality level of sample processed by processing tool. Further technical problems, configurations, or advantages of the present disclosure will be clear from the embodiments below.

### BRIEF DESCRIPTION OF DRAWINGS

FIG. 1 is a configuration diagram of a normality level analyzing system 10 according to an embodiment 1 of the present disclosure.

FIG. 2 is a diagram illustrating a difference between the measuring tools 103-104 and the measuring tool 105.

FIG. 3 illustrates examples of integrated measurement data and test data.

FIG. 4 illustrates a flowchart for the normality level analyzing system 10 to analyze normality level/abnormality level of the sample.

FIG. 5A illustrates a schematic diagram showing a method for calculating normality level/abnormality level.

FIG. 5B illustrate schematic diagrams showing another method for calculating normality level/abnormality level.

FIG. 5C illustrate schematic diagrams showing another method for calculating normality level/abnormality level.

FIG. 6 is a diagram illustrating a display image showing normality level/abnormality level for each of tools.

FIG. 7A is a diagram illustrating a feedback from the test data.

FIG. 7B is a diagram illustrating a feedback from the measurement data.

FIG. 8A illustrates a schematic diagram categorizing the processing tools.

FIG. 8B illustrates a diagram showing normality level/abnormality level calculated by the normality level analyzing system 10.

FIG. 9 is a diagram illustrating a system configuration of the normality level analyzing system 10 according to an embodiment 2.

FIG. 10 schematically illustrates the learning process by the AI engine 106 in the embodiment 2.

FIG. 11 illustrates categories of measurement data.

FIG. 12 is a diagram illustrating an example of temporal variations of number of defect and normality level.

FIG. 13 illustrates an example of the test data.

FIG. 14 illustrates an example of the test data.

FIG. 15 illustrates an example of groups of the measurement data.

FIG. 16 illustrates an example of extended test data.

FIG. 17 illustrates a configuration example of the processing tool.

FIG. 18A illustrates a configuration of the measuring tool.

FIG. 18B illustrates another configuration of the measuring tool.

### DESCRIPTION OF EMBODIMENTS

### Embodiment 1

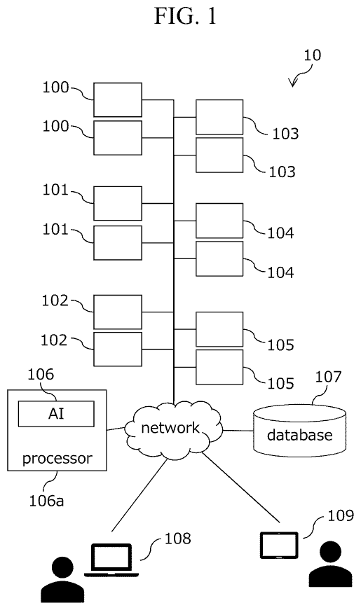

FIG. 1 is a configuration diagram of a normality level analyzing system 10 according to an embodiment 1 of the present disclosure. The normality level analyzing system 10 is a system that analyzes a normality level of a sample processed by processing tools 100-102. The normality level analyzing system 10 includes the processing tools 100-102, measuring tools 103-105, an AI engine 106 (learner), a processor 106a, a database 107 (storage device), a user terminal 108, and an engineer terminal 109. These components are connected to each other by a network. The normality level analyzing system 10 may communicate with other tools or systems via the network.

The processing tools 100-102 are tools that process semiconductor wafers in a semiconductor manufacturing process. Each processing tool may perform different processes, or a part of the processing tools may perform a same process. The processing tools 100-102 are such as etching tool, deposition tool, lithography tool, or CMP (Chemical Mechanical Polishing) tool. The supplier of the processing tools may be a single supplier, or may be a plurality of suppliers.

The measuring tools 103-104 are tools that measure samples (semiconductor wafers in this example) processed by the processing tools 100-102, during the manufacturing process for the wafer. Each measuring tool may perform different measuring processes, or a part of the measuring tools may perform a same measuring process. The measuring tools 103-104 are such as OCD (Optical Critical Dimension), Ellipsometry, SEM (Scanning Electron Microscope), CD-SEM (Critical Dimension SEM), electron beam defect inspection tool, TEM (Transmission Electron Microscope), SAXS (Small Angle X-ray Scattering), AFM (Atomic Force Microscope), mass metrology, or XPS (X-ray Photoelectron Spectroscopy), XRD (X-ray Diffraction). If the processing tool itself includes some measuring function (or tool), the data acquired from such measuring tool is deemed as acquired from the processing tool.

The user terminal 108 and the engineer terminal 109 are electronic terminals such as personal computer or tablets. The user terminal 108 can display states or internal parameters of tools connected to the normality level analyzing system 10. The user terminal 108 can also send tool suppliers information that is necessary for identifying cause of abnormality in the tools 100-105. The engineer terminal 109 also has similar functionalities. The engineer terminal 109 further has a user interface that displays data used for identifying cause of abnormality and for performing measures. The user interface is also used for the user to input details of the measure.

The measuring tool 105 is a tool that measures the wafer after the manufacturing process for the wafer is completed. It is assumed that the completed wafer cannot be put back into the manufacturing process. The measuring tool 105 can be, for example, a SEM or a TEM that performs offline measurement mentioned below.

The AI engine 106 is executed by the processor 106a. The AI engine 106 performs machine learning for estimating a normality level or an abnormality level of the completed wafer, according to measurement result by the measuring tools 103-104. The AI engine 106 estimates a normality level or an abnormality level of the completed wafer on the basis of the machine learning. Details of learning data or the like will be described later. The database 107 can be configured by a storage device that stores each data acquired from the processing tools 100-102 and from the measuring tools 103-105 (i.e. the inline measurement data and the offline measurement data (test data) mentioned below).

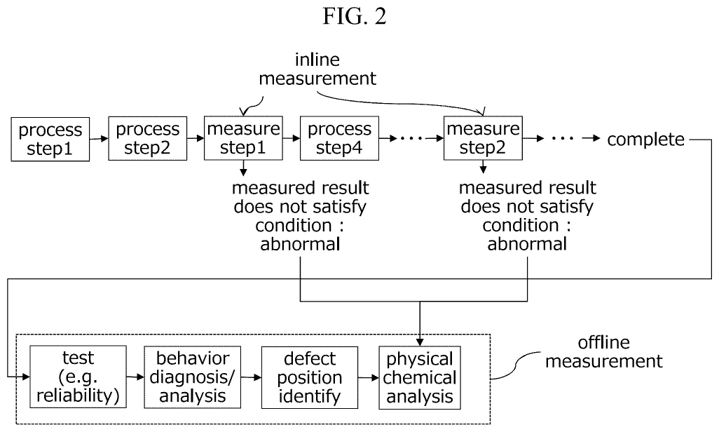

FIG. 2 is a diagram illustrating the difference between the measuring tools 103-104 and the measuring tool 105. An inline measuring tool is a tool that measures a sample during the sample is on the manufacturing process. On the other hand, an offline measuring tool is a tool that measures the sample (a) that is pick out from the manufacturing process when the inline measuring tool detects some abnormality for identifying details of the abnormality, or (b) that has completed the whole manufacturing process for checking electrical characteristics or checking behavior of the sample are correct, for example. Therefore, an inline measurement is for measuring the sample after a processing tool processes the sample so as to check whether the processing tool has processed the sample as desired. If a predetermined condition is not satisfied at inline measurement, it is determined that the sample (or the processing tool) is in abnormal state. Similarly, after the sample has satisfied all inline measuring conditions, the offline measuring tool checks whether the sample can be shipped.

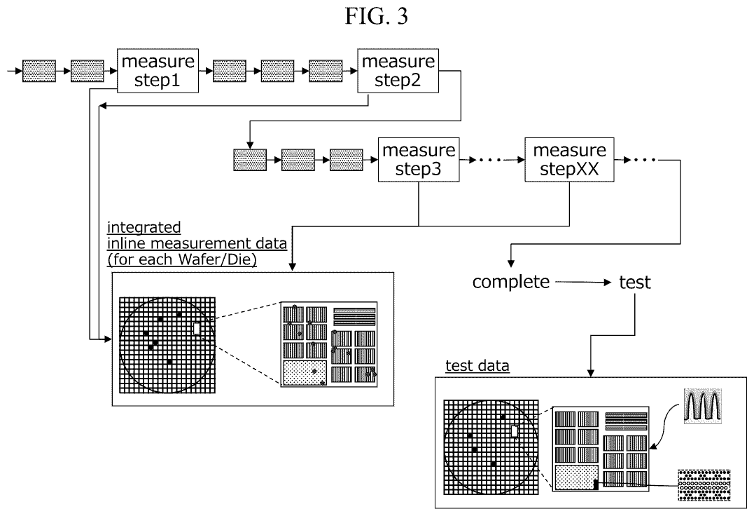

FIG. 3 illustrates examples of integrated measurement data and test data. The integrated inline measurement data is created by integrating measured results each measured by respective inline measuring tools during the sample passes through the manufacturing process. For example, if the inline measuring tool is a defect inspection tool, the measuring tool inspects the number of defects in the wafer. If the number of defects is at or above a threshold, the wafer is categorized as “abnormal”. If the number of defects is below the threshold, the wafer is categorized as “normal”. The processor 106a can create the integrated inline measurement data by integrating measured results that are measured by each of the inline measuring tools.

Specifically, the number of DOI (defect of interest) and the positions of such defects are important for the integrated inline measurement data. The integrated inline measurement data may include all of measured results that are measured by measuring tools before the whole manufacturing process is completed, or may only include measured results that are measured by measuring tools at specific processes. Such specific processes or specific measuring tools may be all or any ones of: processes that are required to be specifically managed; each ones of the inline measuring tools; processes or measuring tools that are specified by the user.

The test data describes the measurement result measured by the offline measuring tool, describing such as whether the completed wafer satisfies test conditions for shipping the wafer. Although the test data is typically generated by the measuring tool 105 (offline measuring tool), any one of inline measuring tools may measure the characteristics of the wafer, and then the inline measured result may be utilized as the test data (e.g. as described in JP6379018B).

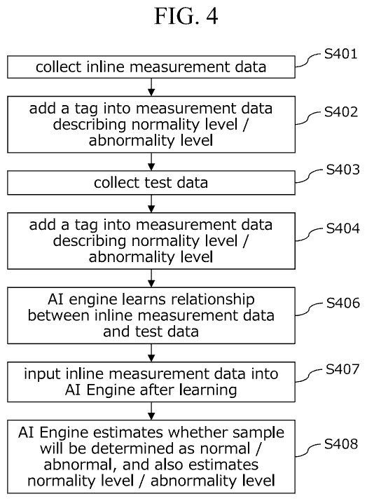

FIG. 4 illustrates a flowchart for the normality level analyzing system 10 to analyze normality level/abnormality level of the sample. Each step in FIG. 4 is performed by the processor 106a or by the AI engine 106.

S401: the processor 106a collects measurement data measured by the inline measuring tools (measuring tools 103-104 in FIG. 1). The processor 106a may collect the measurement data directly from the inline measuring tools, or the inline measuring tools store the inline measurement data into the database 107, and then the processor 106a acquires the inline measurement data from the database 107. The processor 106a identifies the correspondence between the measured result in the measurement data, the measuring tool that measured the result, and the processing tool that caused the measured result. This correspondence may be identified by referring to the ID of the tools stored along with the measurement data, or by the user manually indicating the correspondence, for example.

S402: the processor 106a inputs the inline measurement data into the AI engine 106. The AI engine 106 determines whether the measurement results in the inline measurement data are normal/abnormal, and also determines a normal level/abnormal level, for each of the measurement results. The processor 106a adds a tag into the measurement data that describes whether the measurement results are normal/abnormal, and normal level/abnormal level, for each of the measurement results. Alternatively, the normal level/abnormal level can be determined by the processor 106a. An example for determining normality level/abnormality level will be described later. It also applies to S404.

S403: the processor 106a collects the test data measured by the offline measuring tool (measuring tool 105 in FIG. 1). As in S401, the processor 106a may collect the test data directly from the offline measurement tool, or may acquire the test data from the database 107. Since the measuring speed of the offline measuring tool is much slower than that of the inline measuring tool, the wafer measured by the offline measuring tool may be sampled, or only a part of the completed wafers (e.g. wafers with defects that could not be fully detected by the inline measuring tools) may be measured by the offline measuring tools. In order to supplement such lacked wafers, the processor 106a may use statistics as described in US2020/0312778, or the AI engine 106 may calculate such statistics.

S404: the processor 106a inputs the test data into the AI engine 106. The AI engine 106 determines whether the measurement results in the test data are normal/abnormal, and also determines a normal level/abnormal level, for each of the measurement results. Alternatively, the normal level/abnormal level can be determined by the processor 106a. The processor 106a adds a tag into the test data that describes whether the measurement results are normal/abnormal, and normal level/abnormal level, for each of the measurement results.

S406: the AI engine 106 learns the relationship between the inline measurement data and the test data (i.e. the AI engine 106 performs machine learning process using the inline measurement data and the test data, where the inline measurement data in an input to the AI engine 106, and the test data is an output from the AI engine 106). Accordingly, the AI engine 106 can estimate, by inputting a new piece of inline measurement data into the AI engine 106, a normality level/abnormality level of the measurement results in the test data, which are assumed to be acquired from the offline measuring tool.

S407: the processor 106a acquires a new piece of inline measurement data. The processor 106a inputs the new inline measurement data into the AI engine 106.

S408: the AI engine 106 estimates, from the inputted inline measurement data, whether the offline measuring tool will determines the wafer as normal or abnormal, and also estimates normality level/abnormality level. The normality level/abnormality level indicates that of the sample, which also indirectly indicates normality level/abnormality level of the processing tools. Therefore, the processor 106a can further estimate normality level/abnormality level of the processing tools, according to the estimation from the AI engine 106. The estimation itself may be used as normality level/abnormality level of the processing tools, or some conversion between that of the sample and that of the processing tools may be performed by the processor 106a.

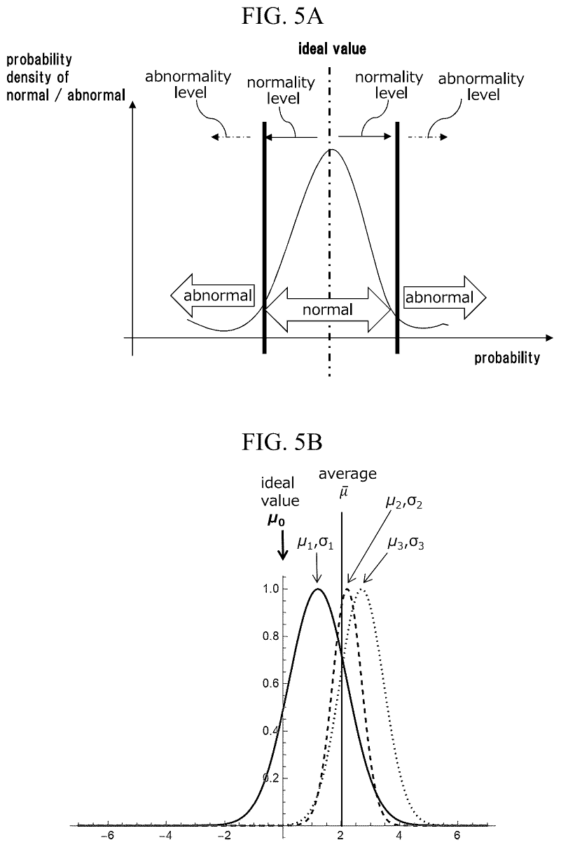

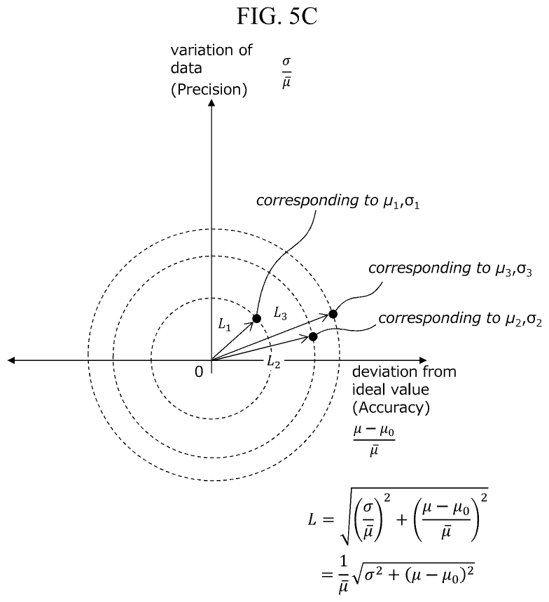

FIG. 5A illustrates a schematic diagram showing a method for calculating normality level/abnormality level. Assuming that the number of normal/abnormal samples distributes according to normal distribution, the distribution may be as shown in FIG. 5A. Samples within a range from the ideal wafer can be identified as normal samples. As the sample deviates from the ideal wafer, the normality level of such sample decreases. Similarly, as the sample deviates from the limit of normal samples, the abnormality level of such sample increases. The processor 106a (or the AI engine 106) can determine normality level/abnormality level of samples by comparing the measurement data or the test data with a predetermined ideal value. S402 and S404 can be performed accordingly. Note that the normality level is highest at value of 0, and is gradually decreased from 0 to positive or negative values, in FIG. 5A.

FIGS. 5B-5C illustrate schematic diagrams showing another method for calculating normality level/abnormality level. Measured results in the measurement data and in the test data are deviated from the ideal value, and the distribution of measured results includes variation. The deviation from the ideal value can be defined as an accuracy of data. The variation of distribution can be defined as a precision of data. The normality level or the abnormality level can be calculated as a distance from the ideal value in the two dimensional space of precision and accuracy.

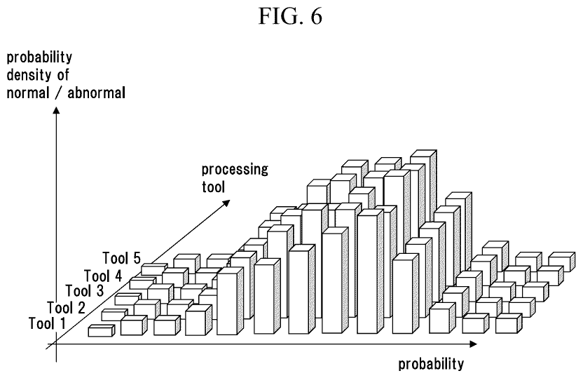

FIG. 6 is a diagram illustrating a display image showing normality level/abnormality level for each of tools. The normality level/abnormality level described in FIGS. 5A-5C can be calculated for each of inline measuring tools or for each of offline measuring tools. The processor 106a may acquire such normality levels/abnormality levels for each tool, and may create a user interface such as in FIG. 6 showing those levels of each tool in parallel. The processor 106a can identify the processing tool measured by the measuring tools, by referring to processing history of the processing tool, for example. The processor 106a then classifies the measurement data or the test data into each processing tool, as shown in the depth direction in FIG. 6. With reference to the user interface shown in FIG. 6, the user can compare the normality level/abnormality level of each processing tool visually.

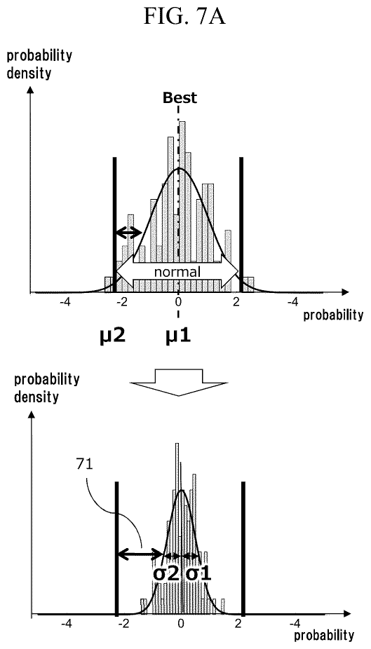

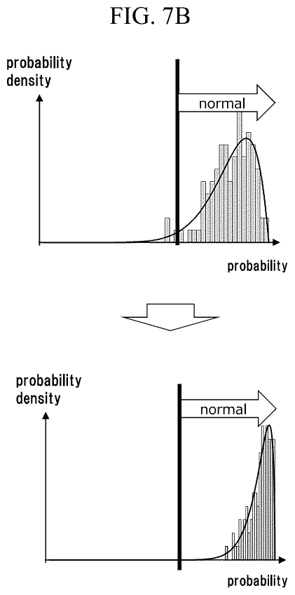

FIG. 7A is a diagram illustrating a feedback from the test data. The upper diagram shows an actual distribution of the test data. An ideal distribution of the test data has a highest peak at the ideal value, and the data points are intensively converged toward the ideal value (i.e. the variation of data is small). The lower diagram shows an example of such ideal distribution. The difference D between the actual test data and the ideal test data can be parameterized using the average μ1, the boundary μ2 between normal data and abnormal data, and standard deviations σ1 and σ2 from the ideal value both at positive side and negative side, such as: D=(μ1−μ2)/(σ1+σ2) which corresponds to the arrow 71. The processor 106a can calculate the difference D, and feeds back such difference to the user. The processor 106a can also calculate distributions for each value of D, and present it to the user on a user interface.

FIG. 7B is a diagram illustrating a feedback from the measurement data. The upper diagram shows an actual distribution of the measurement data. The lower diagram shows an example of ideal distribution of the measurement data. The processor 106a calculates an ideal distribution of the measurement data from the ideal distribution of the test data as shown in FIG. 7A. The processor 106a then feeds back the calculated ideal distribution of the measurement data to the user, such as in a user interface or in the form of data describing the ideal distribution. The processor 106a can search the parameters that achieve the ideal distribution of the measurement data, by varying such parameters using any known searching algorithm, for example. Then the user can identify the ideal distribution of the measurement data, which should be achieved for achieving the ideal distribution of the test data.

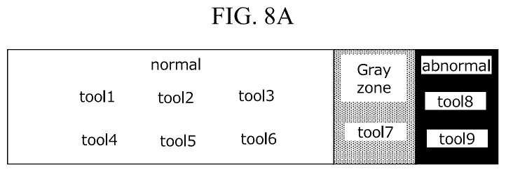

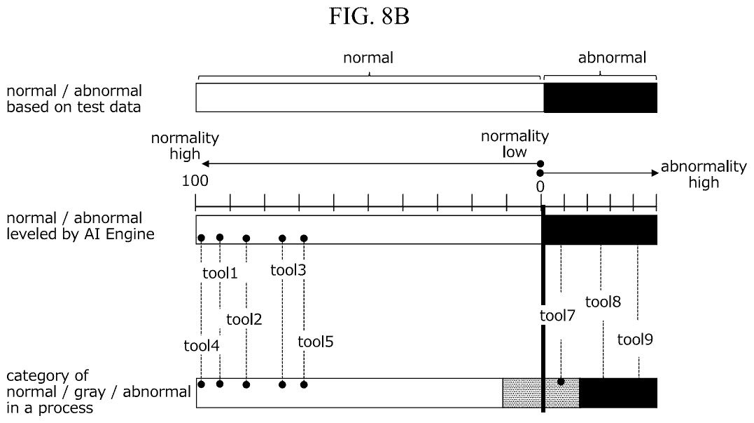

FIG. 8A illustrates a schematic diagram categorizing the processing tools. Conventionally, processing tools are categorized into normal tools or into abnormal tools on the basis of measurement data. However, there are differences in status within each normal/abnormal group, actually. In addition, there are some tools that are categorized as normal or abnormal, but are actually in a gray zone from an engineer's perspective. Conventional categorizing technique on the basis of measurement data does not clearly distinguish such difference or intermediate normal/abnormal level.

FIG. 8B illustrates a diagram showing normality level/abnormality level calculated by the normality level analyzing system 10. In contrast to the conventional categorizing result, the normality level analyzing system 10 does not merely categorize the processing tools into normal/abnormal category, but calculates normality/abnormality levels of each tool. The calculated levels can be shown in a user interface as shown in FIG. 8B. Then it is possible for the user to identify the degree of normality/abnormality in addition to normal/abnormal categories. Further, tools with low normality or abnormality level may be categorized into gray zone, because such tool cannot be clearly categorized into normal nor abnormal. It is also possible for the user to identify such gray zone tools on the user interface.

The normality/abnormality levels can be used for optimizing measuring conditions. For example, now it is assumed that eight etching tools are working in an etching process of semiconductor manufacturing process. The normality level analyzing system 10 calculates normality/abnormality levels, and then seven etching tools have more than 90 normality levels (the maximum normality level is 100). On the other hand, one etching tool has more than 90 abnormality level (the maximum abnormality level is 100). This result indicates that normal tools and abnormal tools are clearly separated from each other, and most of tools are in very excellent working states.

In such cases, since most of tools are in excellent working states, the measuring condition can be less strict to reduce measuring cost, such as by decreasing sensitivity or sampling frequency. In addition, since the abnormal tool is clearly identified, test operators can focus on such abnormal tool, thereby reducing measuring cost. On the other hand, if the normal/abnormal tools are not clearly separated from each other, it is desired to identify the small difference between normal and abnormal tools at early stage, i.e. when measuring the sample by inline measuring tools. Therefore, it is not appropriate to decrease sensitivity or sampling frequency. The measuring condition can be optimized accordingly.

When adjusting the measuring condition, there are two important cautionary matters. The AI engine 106 estimates normality/abnormality levels of the measurement data from inline measuring tools in S402, and also estimates normality/abnormality levels of the test data from offline measuring tools in S404. The AI engine 106 correlates the measurement data with the test data in S406. If the measurement data is highly correlated with the test data, measurement results in the measurement data well describes defects that will be detected as defects in the test data. In such cases, the processing tool is assumed to be in excellent working state, and the inline measuring tool is assumed to be precisely detecting defects. Then even if the measuring conditions of the measuring tools is adjusted to be less strict than usual, it is possible to precisely categorize normal/abnormal samples.

On the other hand, if the measurement data is lowly correlated with the test data, the measuring tools may not be working in excellent state even if the test data well separates normal tools from abnormal tools. In such cases, it is not desirable to adjust the measuring conditions to be less strict than usual. In addition, a measuring process is typically performed after a plurality of processing steps, i.e. a measuring tool measures a sample where a plurality of different processing tools has processed the sample. Therefore, even if most of etching tools are with high normality level, some other processing tools before the etching tools may not be separable between normal and abnormal.

As discussed above, when suggesting to adjust the measuring condition to be less strict than usual, the AI engine 106 (or the processor 106a) has to analyze the measurement data not only from one processing tool but from a plurality of processing tools. This is a first one of the two important cautionary matters.

Measuring conditions may be adjusted when, for example, a reliable measuring tool is not working due to some errors and thus it is necessary to measure samples by temporally using less reliable measuring tools. In such cases, the processor 106a may determine whether the measuring conditions can be less strict according to the normality level/abnormality level discussed in connection with FIG. 8B.

It should be noted that less reliable measuring tools can be used only for temporal use, because even a processing tool with high normality level may be degraded over time. Such temporal change is a second one of the two important cautionary matters. Components of a processing tool will degrade over time. Therefore, a processing tool undergoes cleaning or component replacement after processing a certain amount of samples. Accordingly, a processing tool is not always working in excellent state. For example, a new processing tool (e.g. immediately after shipped or immediately after maintenance) may be with high normality level, whereas a processing tool immediately before maintenance may be with low normality level. Therefore, it is necessary for the AI engine 106 to continuously update normality level of processing tools.

The processor 106a may show a recommendation of measuring condition (e.g. the measuring condition can be less strict than usual, should be as usual, or should be more strict than usual), in a user interface such as shown in FIG. 8A or 8B. For example, tools 1-5 in FIG. 8B may be indicated that the measuring conditions can be less strict than usual, since those tools are in excellent working states.

### Embodiment 1: Summary

The normality level analyzing system 10 according to the embodiment 1 learns a relationship between measurement data of sample acquired by a first measuring tool and test data acquired by a second measuring tool after completing a whole manufacturing process of the sample, wherein the measurement data and the test data both describe normality level/abnormality level of the sample, and the system 10 estimates normality level/abnormality level of the sample that will be measured by the second measuring tool. Accordingly, it is possible to categorize the sample ranging from best normality level to worst abnormality level.

The normality level analyzing system 10 according to the embodiment 1 categorizes the processing tools according to the estimated normality level/abnormality level. Accordingly, the system 10 can identify the processing tool which is under very good condition. Then the user or the system 10 can analyze why such processing tool is under very good condition. Further, the measuring condition or criteria can be optimized such that excessive maintenance operation will be avoided, thereby also decreasing measuring cost.

In the embodiment 1, the normality level/abnormality level determined by the AI engine 106 (or by the processor 106a) may be compared with state data of the processing tools, such as shipping date of the processing tool or maintained date of the processing tool. Accordingly, it is possible to identify the relationship between the elapsed time from shipping date or maintenance date and how much the normality level decreases.

### Embodiment 2

In addition to the inline measuring tool, the manufacturing process may include a quality controlling tool that measures states of the processing tools, using a quality controlling sample (i.e. a sample on which nothing is formed, and thus is used only for measuring the state of a processing tool independently from the actually manufactured samples). The measured result by the quality controlling tool can be used for estimating the measured result by the offline measuring tool, instead of using the inline measurement data. An embodiment 2 of the present disclosure describes such configurations. The configuration of the normality level analyzing system 10 is same as that of the embodiment 1, other than using the quality controlling tool instead of or in addition to the inline measuring tools.

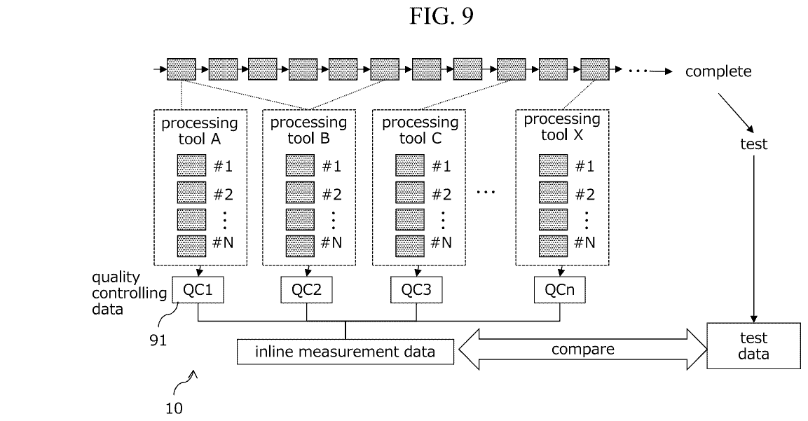

FIG. 9 is a diagram illustrating a system configuration of the normality level analyzing system 10 according to the embodiment 2. As mentioned above, the system 10 includes quality controlling tools 91, each measuring states of the processing tools using a quality controlling dedicated sample such as a bare wafer or non-patterned wafer with single or multiple films deposited. The sample measured by the quality controlling tool 91 is not the product wafer passing through a manufacturing process line. Therefore, the quality controlling data measured by the quality controlling tool 91 cannot be directly associated with the test data. However, the correspondence between the quality controlling data and the processing tool can be identified using such as processing histories of the processing tools. Accordingly, the correspondence between the state of the processing tool and the offline measurement data can be estimated from the quality controlling data. Therefore, the system 10 estimates the test data from the quality controlling data.

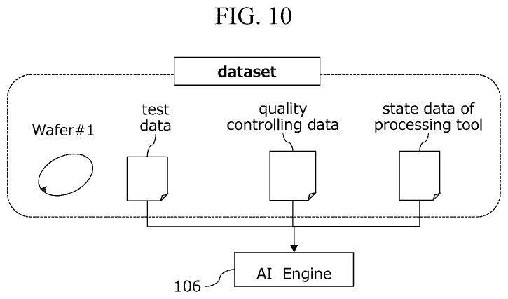

FIG. 10 schematically illustrates the learning process by the AI engine 106 in the embodiment 2. The AI engine 106 learns a relationship between the test data, the quality controlling data, and the internal state data of the processing tool.

Now it is assumed that the processing tool is an etching tool that performs etching process on the sample at a process A. The quality controlling data measured by the quality controlling tool immediately after the process A best describes the state of the etching tool. The quality controlling tool may be a measuring tool that is equipped by the etching tool itself, because such measuring tool can measure the state of the etching tool immediately after performing the etching process. The quality controlling tool measures the state of the quality controlling sample before and after etched, thereby acquiring the quality controlling data.

The AI engine 106 learns the relationship between each data in the dataset (i.e. the test data, the quality controlling data, and the state data). By inputting new pieces of the quality controlling data and the state data, the AI engine 106 estimates the test data achieved under such quality controlling data and state data.

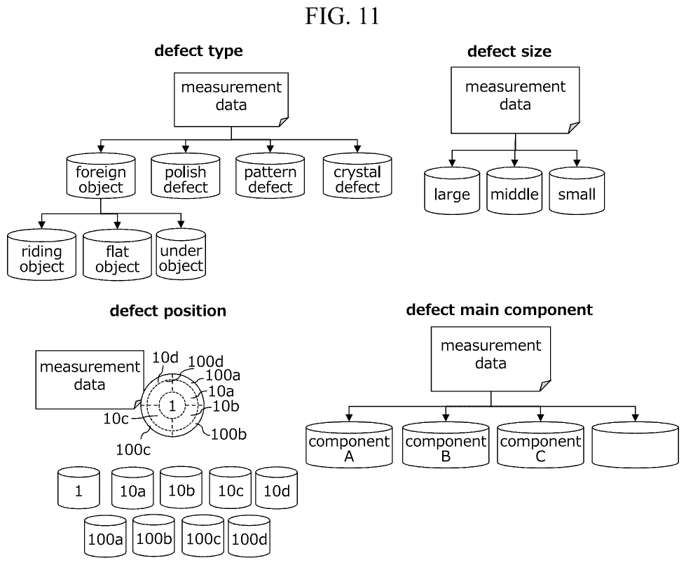

FIG. 11 illustrates categories of measurement data. The measurement data includes various data, such as various categories of defects. If the measurement data only includes number of defects, it may be difficult to identify the relationship between the measurement result and the state data, since the measurement data includes various data other than the number of defects. Therefore, the processor 106a categorizes the measurement data according to such as defect type, defect size, defect position, or defect main component.

Database 107 stores byproduct data that describes a relationship at the processing tool between such as: maintenance history or cleaning history; processing condition; tool-inherent data; amount of byproduct accumulated within a certain period. When the measurement data that categorizes the defect as shown in FIG. 11 is acquired, the processor can correlate the defect and the cause of the defect on the processing tool, by comparing the byproduct data with the quality controlling data. Alternatively, the AI engine 106 may learn the relationship between the measurement data, the test data, and the byproduct data, thereby estimating the cause of byproduct-derived defect.

### Embodiment 3

The embodiment 1 describes that measuring conditions can be optimized by comparing processing tools having high normality level with processing tools having low normality levels. This is primarily based on the normality/abnormality levels estimated by the AI engine 106. On the other hand, a similar comparison can be made between normal processing tools and abnormal processing tools using temporal variation of normality level or temporal variation of number of defects, for example. An embodiment 3 of the present disclosure describes such examples. The configuration of the system 10 is same as described in the embodiments 1-2.

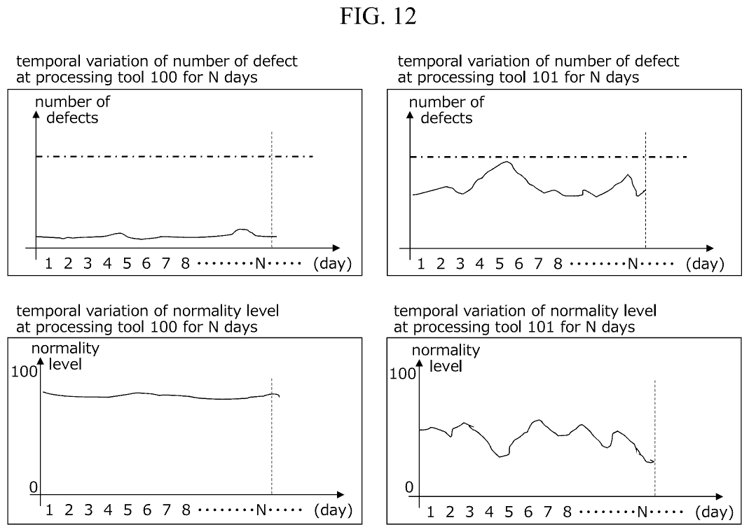

FIG. 12 is a diagram illustrating an example of temporal variations of number of defect and normality level. The processing tool 100 has excellent performance in terms of both number of defects and normality level, for a certain period (N days in this example). The processing tool 101 has poor performance in terms of both number of defects and normality level, for the same period. The processing tools 100 and 101 are of same type of tool and are performing same processing operations. Although those tools are performing same operations, there exists a difference in their performances. The normality level analyzing system 10 uses, for example, the categories of defect from the measurement data to analyze the cause of the performance difference between the processing tools 100 and 101.

Now it is assumed that the processor 106a identifies, from the measurement data, that the processing tool 101 produces defects having similar appearances and having similar components, whereas the processing tool 100 does not produce such defects. On the other hand, as mentioned in the embodiment 2, the database 107 stores maintenance histories or cleaning histories of the processing tool. By referring to the database 107, the processor 106a can identify that relatively short time span has elapsed from the cleaning data for the processing tool 100, whereas relatively long time span has elapsed from the cleaning date for the processing tool 101, for example. The processor 106a compares defect information from the measurement data with the information in the database 107. Then the processor 106a can identify, for example, that: longer elapsed time from the cleaning date may accumulates more amount of byproducts; and that accumulated byproducts deteriorates number of defects.

By comparing the processing tools 100 and 101 as above, the processor 106a can identify the cause of deterioration in the processing tool 101, such as the difference of processing parameters (e.g. processing recipe) between those tools or internal errors within those tools, since such difference is expected to be the cause of deterioration. After identifying the cause of poor performance of the processing tool 101, it is possible to, for example: adjust maintenance timing or cleaning condition; improve in-situ cleaning operation which is performed in order to initialize states of processing tools.

### Embodiment 3: Summary

The normality level analyzing system 10 according to the embodiment 3 compares temporal variations of normality levels between the processing tools 100 and 101, where the processing tool 100 has excellent performance and the processing tool 101 has poor performance. Accordingly, it is possible to estimate the cause of deterioration by identifying parameters which do not exist in the processing tool 100 but exist in the processing tool 101, for example.

### Embodiment 4

The embodiments 1-3 describe that the AI engine 106 estimates the relationship between the measurement data and the test data. Such estimates may be improved by providing the AI engine 106 with more detailed information. An embodiment 4 of the present disclosure describes such detailed information. The configuration of the system 10 is same as in the embodiments 1-3.

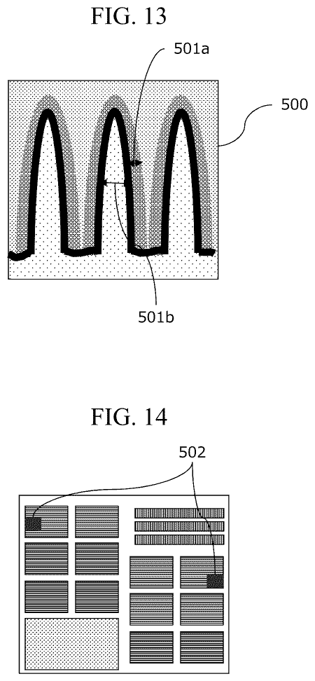

FIG. 13 illustrates an example of the test data. The test data may include an observed image of the sample captured by Scanning Electron Microscope or Transmission Electron Microscope. FIG. 13 shows such example of an image 500. The image 500 includes sizes 501a and 501b of specific portions formed in the sample. If such sizes are not within a predetermined range, the deviation from the predetermined range may be utilized when estimating the normality/abnormality levels.

FIG. 14 illustrates an example of the test data. The test data may include areas that are expected to be defective or to be normal. The processor 106 can statistically identify such areas from the test data. Alternatively, the AI engine 106 can learn the relationship between the measurement data and the test data so as to estimate such areas from the test data. The processor 106 can reflect the information about the areas into the inline measurement data, for example. Then the user can see such areas along with the measurement data visually, and then the user may adjust measuring conditions or processing conditions in accordance with the areas.

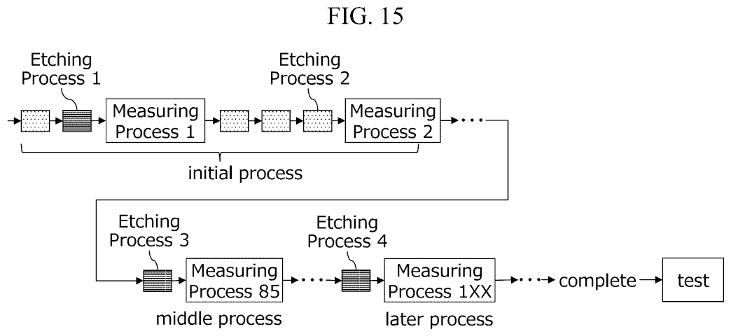

FIG. 15 illustrates an example of groups of the measurement data. The manufacturing process uses four inline measuring tools 1, 2, 85, and 1XX in FIG. 15. Each measuring tool is a same type of tool but used for the different etching process and status of the sample in the whole manufacturing process. The measuring tool 1 measures the output from the etching process 1, the measuring tool 2 measures the output from the etching process 2, the measuring tool 85 measures the output from the etching process 3, and the measuring tool 1XX measures the output from the etching process 4. Therefore, the inline measurement data in FIG. 15 can be grouped into four groups, each corresponding to the respective measuring tools. Then AI engine 106 estimates normality/abnormality levels for each of the groups.

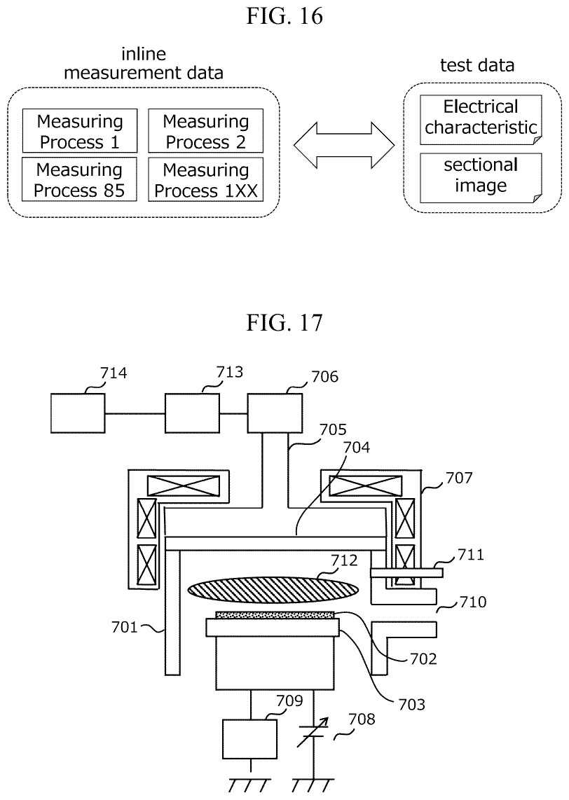

FIG. 16 illustrates an example of extended test data. The test data typically includes electrical characteristics of the sample. The test data may be extended by including sectional images of the sample, for example. The sectional image may include a portion where a measuring tool found an error. By increasing amount of information in the test data, it is further readily possible to estimate the relationship between the measurement data and the test data by the AI engine 106.

### Embodiment 5

An embodiment 5 of the present disclosure describes examples of the processing tool and the measurement tool. The configuration of the system 10 is same as those in the embodiments 1-4.

FIG. 17 illustrates a configuration example of the processing tool. The processing tool shown in FIG. 17 is a plasma processing tool. The plasma processing tool is, for example, an etching tool or a deposition tool. The plasma processing tool includes: a vacuum processing chamber 701; a lower electrode (sample stage) 703 provided in the vacuum processing chamber 701; a microwave transmission window 704 such as quartz; a waveguide 705 provided above the microwave transmission window 704; a magnetron (plasma generating tool) 706; a magnetron driving power source 713; a solenoid coil 707 provided around the vacuum processing chamber 701; an electrostatic attraction power source 708 connected to the lower electrode 703; a substrate bias power source 709; and a power controller 714 for controlling the power supply of the magnetron driving power source 713 and of the substrate bias power source 709.

The lower electrode 703 includes a wafer mounting surface for holding the wafer 702. The magnetron driving power source 713 supplies the plasma generating power to the magnetron 706, and the substrate bias power source 709 supplies the substrate bias power to the lower electrode 703. Further, a wafer loading port 710 is provided for loading or unloading the wafer 702 into or from the vacuum processing chamber 701, and a gas supply port 711 for supplying a gas to the vacuum processing chamber 701 is provided.

The operation of the plasma processing tool configured as described above will be described below. After the inside of the vacuum processing chamber 701 is depressurized, the etching gas is supplied from the gas supply port 711 into the vacuum processing chamber 701 and is adjusted to a desired pressure. Subsequently, a DC voltage of several hundred volts is applied by the electrostatic attraction power source 708, whereby the wafer 702 is electrostatically attracted to the mounting surface above the lower electrode 703. Thereafter, when plasma generating power is supplied from the magnetron driving power source 713 (on state), microwaves in the frequency of 2.45 GHz are oscillated from the magnetron 706. This microwave is propagated through the waveguide 705 into the vacuum processing chamber 701. When the power for plasma generation is not supplied (off state), the magnetron 706 stops the oscillation of the microwave. A magnetic field is generated in the vacuum processing chamber 701 by the solenoid coil 707. A high density plasma is generated in the vacuum processing chamber 701 by the interaction between the magnetic field and the oscillated microwave. After the plasma 112 is generated, high frequency power is supplied from the substrate bias power source 709 to the lower electrode 703. The energy at which ions in the plasma enter the wafer is controlled, whereby the etching process of the wafer 702 can be performed.

The normality level analyzing system 10 can acquire, for example, the following data from the plasma processing tool. These data represent the state when the plasma processing tool is performing the etching process.

### (1) Sensor Data

The controller that controls the operation of the plasma processing tool can create and record the following operation logs at the start and end of the operation command.
process log: logs relating to wafer processing in the vacuum processing chamber 701, e.g., start/end of processing
transport log: robot operation logs related to wafer transfer, e.g. start/end of loading/unloading operation
functional log: logs related to hardware operation, e.g. start/end of vent/exhaust
lot event log: logs related to operation of lots, e.g. installation/recall of hoops, start/end of process job

### (2) In-Situ Process Monitor Data

For example, a detection value of a sensor for monitoring an etching process can be obtained via a tool controller. As an example, a detection value such as a sensor that detects a change in a plasma state or a sensor that measures a wafer film thickness can be acquired.
End Point Detection (etching end monitor): plasma chemistry change
Film Thickness Monitor (film thickness and depth monitor): wafer thin film, optical interferometry

### (3) Data Collection System

The tool controller can record the following processing conditions for plasma processing.
tool data: acquired by collecting process condition parameters in 0.1 second cycles (e.g., μ wave, bias power, pressure, gas flow rate, chamber temperature, etc.)
light emission data
   (4) tool specific data: component arrangement, material information, and the like can be stored in the database 107 in advance. The database 107 may be updated at the time of tool upgrade or the like.

### (5) Processing Tool Maintenance History

### (6) Processing Tool Treatment Or Cleaning Conditions

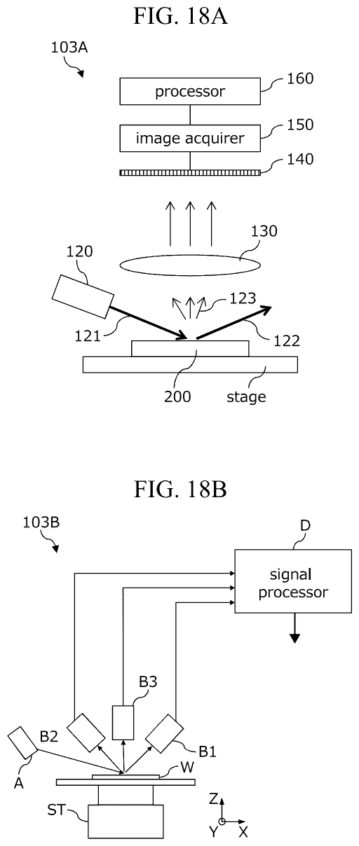

FIG. 18A illustrates a configuration of the measuring tool. The measuring tool in FIG. 18A is configured as an optical defect inspection tool 103A. The measured object may be a mask, a wafer, or the like, and the wafer may be patterned or unpatterned. FIG. 18A is a configuration example for measuring a defect of a patterned wafer. The optical defect inspecting apparatus 103A includes a stage, a light source 120, an optical lens 130, a camera (sensor) 140, an image acquirer 150, and a processor 160.

A chip (die) is arranged on the wafer 200 in XY direction. The stage moves the wafer 200 at least in a planar direction (XY direction). The light source 120 irradiates the wafer 200 with light 121 from above or obliquely above. When the light 121 impinges on the wafer 200, reflected light 122 and scattered light 123 (both signal light) originate from the wafer 200. The optical lens 130 directs the reflected light 122 or the scattered light 123 to the imaging surface of the camera (sensor) 140. The camera (sensor) 140 images the reflected light 122 or the scattered light 123. The inspection apparatus for imaging and inspecting the reflected light 122 is referred to as a bright field inspection apparatus, and the apparatus for imaging and inspecting the scattered light 123 is referred to as a dark field inspection apparatus. In a case where there is a repeat pattern at a certain interval on the wafer 200, a spatial filter that cuts off light corresponding to the interval of the repetitive pattern may be provided, and the optical lens 130 may be disposed before and after the spatial filter. The image acquirer 150 acquires an image of the wafer 200 using the imaging signal acquired by the camera (sensor) 140. By comparing this image with a database, with a reference image, with an adjacent die image, etc. for each of chip (die), the light from the pattern and the light from the defect are distinguished from each other, thereby detecting the defect.

FIG. 18B illustrates another configuration of the measuring tool. The measuring tool in FIG. 18B is configured as an optical defect inspection tool 103B. This measuring tool measures defects of a non-patterned wafer. The sample W is placed on the rotational stage ST, and the sample W is irradiated with light from the light source A.

The signal light generated from the sample W is detected by detectors (three detector B1-B3 are shown as an example) which are installed in different subjective and/or azimuth directions with respect to the sample W. The detector outputs a detection signal representing a detection result of the detected light. The signal processor D detects a defect on the sample W by analyzing the detection signal.

### Modification of Present Disclosure

The present disclosure is not limited to the embodiments described above, and includes various modifications. For example, the embodiments described above are described in detail to facilitate understanding of the present disclosure, and it is not necessary to include all of the configurations described. A part of one embodiment can be replaced with a configuration of another embodiment. A configuration of another embodiment can be added to a configuration of one embodiment. A part of a configuration of each embodiment may be deleted, added with a part of a configuration of another embodiment, or replaced with a part of a configuration of another embodiment.

In the embodiments above, the system 10 includes the processing tools 100-102 and the measuring tools 103-105, for the sake of simplifying the description. However, all or a part of those tools may be configured as tools from separated from the system 10, and the system 10 may acquire various data from those tools.

In the embodiments above, the AI engine 106 and the processor 106a may be constructed by hardware such as circuit devices implementing the functionalities of those components, or may be constructed by software implementing the functionalities of those components and processors such as CPU (Central Processing Unit) executing the software.

### REFERENCE SIGNS LIST

1: normality level analyzing system
106: AI engine
106a: processor
107: database

1. A normality level analyzing system for analyzing a normality level of a sample processed by a processing tool, comprising:
a storage device that stores: measurement data that describes a measurement result acquired by a first measuring tool which measures the sample; and test data that describes a measurement result acquired by a second measuring tool which measures the sample after a whole manufacturing process for the sample is finished ;
a learner that learns a relationship between the measurement data and the test data; and
a processor that estimates a normality level of the sample using the leaner,
wherein the processor additionally describes, into the measurement data, a normality level or an abnormality level of the sample measured by the first measuring tool,
wherein the processor describes, into the test data, a normality level or an abnormality level of the sample measured by the second measuring tool,
wherein the learner is configured to, according to a result of learning the relationship between the measurement data and the test data, receive the measurement data, thereby outputting a normality level or an abnormality level of the sample, and
wherein the processor inputs the measurement data into the learner to acquire an output from the learner, thereby estimating a normality level or an abnormality level of the sample that will be measured by the second measuring tool.

2. The normality level analyzing system according to claim 1,
wherein the processor estimates a normality level or an abnormality level of the processing tool according to the estimated normality level or abnormality level of the sample.

3. The normality level analyzing system according to claim 1,
wherein the processor calculates a deviation, from an ideal value, of a measured value measured by the first measuring tool,
wherein the processor calculates a variation of a measured value measured by the first measuring tool,
wherein the processor calculates a normality level or an abnormality level of the sample measured by the first measuring tool according to the deviation and to the variation, and
wherein the processor additionally describes the calculated normality level or the calculated abnormality level into the measurement data.

4. The normality level analyzing system according to claim 1,
wherein a plurality of the sample is processed by a plurality of the processing tools,
wherein the processor identifies, among the plurality of the processing tools, the processing tool that processes the sample described in the measurement data and in the test data, by referring to history data that describes a processing history performed by the processing tool, and
wherein the processor categorizes measurement results in the measurement data and in the test data into each of the identified processing tool.

5. The normality level analyzing system according to claim 1,
wherein the processor calculates an ideal distribution of the measurement data that brings, if acquired from the first measuring tool, a distribution of the test data into more ideal distribution than an actual distribution of the test data.

6. The normality level analyzing system according to claim 2,
wherein the processor provides a user interface that presents the estimated normality level or abnormality level of the processing tool.

7. The normality level analyzing system according to claim 6,
wherein the processor presents, in the user interface, a candidate of measuring condition for the first measuring tool or for the second measuring tool, according to the estimated normality level or abnormality level of the processing tool, such that the candidate indicates less strict measuring condition as the estimated normality level is higher or the estimated abnormality level is lower.

8. The normality level analyzing system according to claim 1,
wherein the first measuring tool measures a first type of the non-patterned sample, the first type of the sample being processed by the processing tool during quality controlling process for the processing tool, and
wherein the second measuring tool measures a second type of the sample which is the product wafer passing through a manufacturing process line.

9. The normality level analyzing system according to claim 1,
wherein the storage device further stores state data that describes an internal state of the processing tool,
wherein the learner learns a relationship between the measurement data, the test data, and the state data, and
wherein the processor inputs the measurement data and the state data into the learner to acquire an output from the learner, thereby estimating a normality level or an abnormality level of the sample measured by the second measuring tool.

10. The normality level analyzing system according to claim 1,
wherein the measurement data describes a category of a defect in the sample,
wherein the storage device stores byproduct data that describes a relationship between a type of a byproduct that can be generated by the processing tool, maintenance history of the processing tool, and a processing condition of the processing tool when the byproduct is generated,
wherein the learner learns the relationship between the measurement data, the test data, and the byproduct data, and
wherein the processor inputs the measurement data and the byproduct data into the learner to acquire an output from the learner, thereby estimating a cause of a defect in the sample that is caused by a byproduct generated by the processing tool.

11. The normality level analyzing system according to claim 1,
wherein the processor acquires a first processing parameter used in a first one of the processing tool for processing the sample, the first one of the processing tool having a first value of the normality level,
wherein the processor acquires a second processing parameter used in a second one of the processing tool for processing the sample, the second one of the processing tool having a second value of the normality level worse than the first value,
wherein the processor reconfigures the second processing parameter to be closer to the first processing parameter, thereby improving normality level of the second processing tool.

12. The normality level analyzing system according to claim 1,
wherein the second measuring tool detects a defect in the sample and a position of the defect in the sample,
wherein the test data describes the position of the defect in the sample,
wherein the learner learns a relationship between the measurement data and the test data, thereby being configured to estimate an area in the measurement data where a defect is caused, and
wherein the processor reflects, into the measurement data, an area where the learner estimates that a defect is caused.

13. The normality level analyzing system according to claim 1,
wherein the processor groups measurement results described in the measurement data, and
wherein the learner learns a relationship between the measurement data and the test data for each of groups grouped by the processor, thereby being configured to estimate a normality level or an abnormality level of the sample for each of the groups.

14. The normality level analyzing system according to claim 13,
wherein a plurality of the processing tools processes the sample, each of the plurality of the processing tools using different processing parameters to process the sample respectively, and
wherein the processor groups measurement results in the measurement data, for the processing tool using a same one of the processing parameters, into a same group.

15. The normality level analyzing system according to claim 1,
wherein the second measuring tool measures at least one of: an electrical characteristic of the sample; or a size of a pattern formed in the sample measured by irradiating a charged particle beam onto the sample, and
wherein the test data describes at least one of: a measurement result for an electrical characteristic of the sample; or a measurement result for a size of a pattern formed in the sample.
